(19) United States
(12) Patent Application Publication
(10) Pub. No.: US 2007/0095752 A1
(43) Pub. Date: May 3, 2007

(54) SYSTEM FOR CREATING MOTION IN A LIQUID, IN PARTICULAR RESULTING IN WAVES AT THE SURFACE THEREOF

(75) Inventor: Joseph DEMARTEAU, Namur (BE)

Correspondence Address: SUGHRUE MION, PLLC, 2100 PENNSYLVANIA AVENUE, N.W., SUITE 800, WASHINGTON, DC, 20037, US

(73) Assignee: WOW COMPANY S.A.

(21) Appl. No.: 11/276,891

(22) Filed: Mar. 17, 2006

Related U.S. Application Data
(63) Continuation-in-part of application No. 10/765,282, filed on Jan. 28, 2004, now abandoned.

(30) Foreign Application Priority Data
Jan. 29, 2003 (BE) 2003/063

(51) Int. Cl. B01D 11/04

(52) U.S. Cl. 210/634

(57) ABSTRACT

System for creating a liquid motion in a pool comprising: a means for introducing intermittently a gas into the liquid a gas flow means adapted for increasing the pressure of the gas, said increase resulting in gas flow and a control means for controlling the flow of the gas at the end opening of the end piping assembly at least in function of the height of the liquid.

This application is a continuation in part of USSN 10/765,282 filed on Jan. 28, 2004 and published under number US2004/216226 on Nov. 4, 2004, claiming the benefit of the priority of Belgian patent application 2003/0063 filed on Jan. 29, 2003. The content of said US application is incorporated in the present specification by reference.

### FIELD OF THE INVENTION

The invention relates to a system for creating a motion in a liquid, in particular resulting in waves at the surface thereof, in which a gas in injected below the surface of said liquid, said gas moving upwardly in the liquid before escaping from said liquid.

### THE PRIOR ART

A number of wave-making systems have already been proposed.

Thus, it has been proposed that the side wall of a swimming pool or its bottom be fitted with a pipe attached to a piston such that, as water is sucked through one end of the pipe, water exits at the other end into the pool. The creation of movement requires a considerable quantity of water to be impelled and expelled.

There have also been proposals for objects that are to move in a vertical plane above the surface of the pool. Such mechanisms have the disadvantage of being too visible and do not provide optimal functionality.

It is also known that there are baths equipped with jet streams that provide large volumes of water, in which the water output is substantially horizontal. The jet may or may not be controlled according to the state of the surface of an area of the bath.

Motion in a liquid or at the surface thereof, may be also created with pool aerator, for example in Jacuzzi®. Nevertheless bubbling generates an uncontrolled motion in the liquid and is not able to create nice waves in the liquid.

Finally, there is also a floating ball (WOW® as marketed by the applicant) capable of creating waves on the surface of the water in a swimming pool. Such a ball requires only little energy to create waves, provides excellent amplification of wave movement, this amplification being progressive. Such a floating ball does however reduce the usable surface of the pool, both by its volume and by its location (in the middle of the pool, or at least, away from its edges.) Such a ball can be fairly heavy.

It is also known system with one or more gas chambers with an opening located under the water level of the pool. Said large chambers are connected to a gas flow means, so as to push water from the chamber downwardly into the pool so as to increase the water level and so as to suck water of the pool into the chamber so as to decrease the water level in the pool. Such a system requires the displacement of large quantity of liquid. Moreover, such device consumes a great deal of energy and implies additional space and costs for the chambers.

The present invention relates to a simple system that allows the creation and the control of movements in a liquid, in particular in the liquid surface; the said system offers one or more of the following advantages:

system can be placed in parts of the pool not used for swimming

easily installed in an existing pool
better movement or turbulence of the water along the pool walls,
system is not much visible
possibility of creating massage areas in a section of the pool
very safe system from the point of view of swimmers' safety
excellent aeration of the pool or bath,
etc.

### BRIEF DESCRIPTION OF THE INVENTION

The invention relates to a system for creating a motion selected from the group consisting of liquid motions in a liquid, liquid motions at the surface of a liquid (in particular resulting in waves at the surface thereof) and combinations thereof, the said liquid being contained in a pool presenting an average level, said motions or waves following at least one substantially sinusoidal pattern having a motion or wave length, a frequency or a phase period corresponding to the inverse of the frequency and with a height varying between a bottom level below the average level at specific moments and a top level above the average level at specific other moments, this system being:
a system comprising:
   a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
   a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters, and
   a control means for controlling the flow of the gas at the end opening of the end piping assembly at least in function of the height of the liquid, especially wave vertically above the end opening, said control means being adapted for achieving, said at least one pattern, to permit the gas flow means to increase the pressure of the gas, said increase resulting in gas flow at the end opening of the end piping assembly at first moments for which the liquid or wave above the open end assembly is in phase corresponding to an advance of phase comprised between 0° and 180° with respect to moments of low level of the phase of the liquid motion or wave, up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly to the surface of the liquid with an additional liquid height of 5 meters, while said control means is adapted for maintaining the pressure in the end piping assembly at or slightly below a pressure corresponding to the liquid height above the end piping assembly for the liquid motion phases or wave phases except the said first moments,
      and/or
a system comprising
   a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
   a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters, and
   a control means for controlling the flow of the gas at the end opening of the end piping assembly at least in function of the height of the motion vertically above the end opening, said control means being adapted for achieving, said at least one pattern, to permit gas flow at the end opening of the end piping assembly at first moments for which the liquid above the open end assembly is in phase corresponding to an advance of phase comprised between 0° and 180° with respect to moments of low level of the phase of the motion, said gas flowing at a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly to the surface of the liquid with an additional liquid height of 5 meters, while said control means is adapted for stopping the liquid flow through the end opening for the motion phases except the said first moments.

Preferably, the flow rate of gas introduced intermittently into the liquid at each end piping assembly is less than 100 litres of gas per second, advantageously less than 40 litres of gas per second.

Advantageously, said control means is adapted for achieving said at least one pattern to permit the gas flow means to increase the pressure of the gas, said increase resulting in gas flow at the end opening of the end piping assembly at first moments for which the liquid motion or wave above the end opening is in a phase corresponding to an advance of phase comprised between 5° and 90°, preferably comprised between 10° and 45°, with respect to moments of low level of the phase of the liquid motion or wave, up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping and an additional liquid height of 5 meters, advantageously of less than 5 meters, preferably of 1 meter or less.

According to an advantageous embodiment, the end opening has a total open end cross section of at least 5 cm² within a pattern with an area of 1 m². Said total open end cross section is advantageously comprised between 6 cm² and 100 cm², preferably between 10 cm² and 50 cm².

According to a possible embodiment, for example when the average liquid level of the pool is above 1.2 m, there is only a single end opening communicating with the pool. Possibly, the open end system comprises several distinct openings communicating with the pool, for example when the average liquid level of the pool is below 1.2 m.

According to an advantageous detail, the end piping assembly is provided with a non-return valve so that the liquid can't penetrate into the end piping assembly.

According to a specific embodiment, the means for introducing intermittently a gas into the liquid is a system mobile between at least an open position and a closed position. Such a system controls then the release of gas at the end piping assembly in the form of one single bubble or more bubbles. Advantageously, the said means is placed near the end piping assembly. According to a detail, the said means corresponds to the end piping assembly.

According to a detail, the open end system is located at least 50 cm below the average level of liquid in the pool, preferably between 100 cm and 300 cm below the average level of liquid in the pool. Advantageously, the open end system is placed on the bottom of the pool.

According to another detail, the control means is adapted for controlling the escape of gas from each end piping assembly into the liquid during a time period corresponding ideally to less than 0.8 times the phase period of the liquid motion or wave, advantageously during a time period comprised between 0.1 and 0.5 times the phase period of the liquid motion or wave.

The invention relates also to a pool adapted for containing a liquid with an average level, said pool being provided with a system for creating a motion selected from the group consisting of liquid motions in a liquid, liquid motions at the surface of a liquid ( in particular resulting in waves at the surface thereof) and combinations thereof, said liquid motions or waves following at least one substantially sinusoidal pattern having a phase and with a height varying between a bottom level below the average level at specific moments and a top level above the average level at specific other moments, whereby this system is
a system comprising:
   a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
   a gas flow means adapted for increasing the pressure of the gas, said increase resulting in gas flow at the end opening of the end piping assembly, up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters, and [symbol] corresponding to the liquid height from the end opening up to the surface of the liquid,
   a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters, and
   a control means for controlling the flow of the gas at the end opening of the end piping assembly at least in function of the height of the motion vertically above the end opening, said control means being adapted for achieving, said at least one pattern, to permit gas flow at the end opening of the end piping assembly at first moments for which the liquid above the open end assembly is in phase corresponding to an advance of phase comprised between 0° and 180° with respect to moments of low level of the phase of the motion, said gas flowing at a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly to the surface of the liquid with an additional liquid height of 5 meters, while said control means is adapted for stopping the liquid flow through the end opening for the motion phases except the said first moments.

The pool is advantageously provided with a system of the invention having one or more characteristics of the system of the invention disclosed here above.

The invention further relates to a method for creating a motion selected from the group consisting of liquid motions in a liquid, liquid motions at the surface of a liquid (in particular resulting in waves at the surface thereof) and combinations thereof, said liquid contained in a pool presenting an average level, said waves following at least one substantially sinusoidal pattern having a phase and with a height varying between a bottom level below the average level at specific moments and a top level above the average level at specific other moments, said method being a method comprising the step of:
introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
increasing the pressure of the gas by a gas flow means, said increase resulting in gas flow at the said end opening of the end piping assembly up to a pressure greater than the pressure corresponding to the sum of the liquid height form the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters, and
controlling by a control means the flow of the gas at the end opening of the end piping assembly at least in function of the height of the liquid or wave vertically above the end opening, said control means being adapted for achieving, said at least one pattern, to permit the gas flow means to increase the pressure of the gas, said increase resulting in gas flow at the end opening of the end piping assembly at first moments for which the liquid or wave above the open end assembly is in phase corresponding to an advance of phase comprised between 0° and 180° with respect to moments of low level of the phase of the liquid motion or wave, up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly to the surface of the liquid with an additional liquid height of 5 meters, while said control means is adapted for maintaining the pressure in the end piping assembly at or slightly below a pressure corresponding to the liquid height above the end piping assembly for the motion phases or wave phases except the said first moments,
   and/or
a method comprising the step of:
   introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
   controlling the gas flow flowing through the end opening of the open end piping assembly, said gas flowing at a pressure greater than the pressure corresponding to the sum of the liquid height form the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping assembly and an additional liquid height of 5 meters,
   whereby said gas flow control is operated by a control means at least in function of the height of the liquid vertically above the end opening, said control means being adapted for achieving a gas flow at said end piping assembly at first moments for which the liquid motion above the open end assembly is in a phase corresponding to an advance of phase comprised between 0° and 180° with respect to moments of low level of the phase of the liquid motion, while said control means is adapted for preventing the gas flow in said liquid through said end piping assembly for the liquid motion phases except the said first moments.

Advantageously, for achieving said at least one wave pattern, the controlling step is adapted to permit the gas flow means to increase the pressure of the gas, said increase resulting in gas flow at the end opening of the end piping assembly piping assembly at first moments for which the liquid or wave above the open end assembly is in an phase corresponding to an advance of phase comprised between 5° and 90°, preferably between 10° and 45° with respect to moments of low level of the phase of the liquid motion or wave, up to a pressure greater than the pressure corresponding to the sum of the liquid height from the end opening of the end piping assembly to the surface of the liquid with an additional liquid height of at least 5 cm (when the liquid surface is submitted to a pressure, such as the atmospheric pressure or maintained under pressure, the pressure of gas is increased above the sum of the pressure exerted at the surface+the liquid height from the end opening up to the surface+at least 5 cm liquid height), but lower than a pressure corresponding to the sum of the liquid height from the end opening of the end piping-assembly and an additional liquid height of 5 meters.

According to a preferred embodiment, for achieving said at least one liquid motion or wave pattern, the controlling step is adapted to permit the gas flow means to increase the pressure of the gas, said increase resulting in gas flow at said end piping assembly at first moments for which the wave above the open end assembly is in an phase corresponding to an advance of phase comprised between 5° and 90°, advantageously between 10° and 45° with respect to moments of low level of the phase of the liquid motion or wave, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

Preferably, the open end system has a total open end cross section of at least 2 cm² within a pattern with an area of 1 m², most preferably comprised between 6 cm² and 100 cm², especially between 10 cm² and 50 cm².

According to a detail embodiment, for example when the average liquid level of the pool is above 1.2 m, there is only a single end opening communicating with the pool. Possibly, the open end system comprises several distinct openings communicating with the pool, for example when the average liquid level of the pool is below 1.2 m.

Preferably, the open end system is located at least 50 cm, preferably between 100 cm and 300 cm below the average liquid level of liquid in the pool. Advantageously, the end opening is placed on the bottom of the pool.

According to a further detail, the control means is adapted for controlling the escape of gas from each end piping assembly into the liquid during a time period corresponding ideally to less than 0.8 times, preferably comprised between 0.1 and 0.5 times the phase period of the wave.

The invention further relates to the use of a system of the invention for various uses, such as swimming pool, water treatment plant, aeration plant, etc.

Details and characteristics of preferred embodiment of the invention will appear from the following description, in which reference is made to the following drawings.

### BRIEF DESCRIPTION OF THE DRAWINGS

In said drawings,

FIG. 1 is a schematic transversal cross section view of a pool provided with a system for creating waves.

FIGS. 2A and 2B are schematic views of end piping assemblies

FIG. 2C is a schematic view of end piping assembly provided with non-return valve.

FIG. 3A and 3B are schematic views of control means for introducing intermittently a gas into the liquid, in an open position and in a closed position

FIG. 4 is a schematic view of another control means specially dedicated for a two end piping assemblies embodiment

FIGS. 5 and 6 are schematic views of a wave in a position corresponding to the moment of introduction of the air and in a position for which no air is introduced

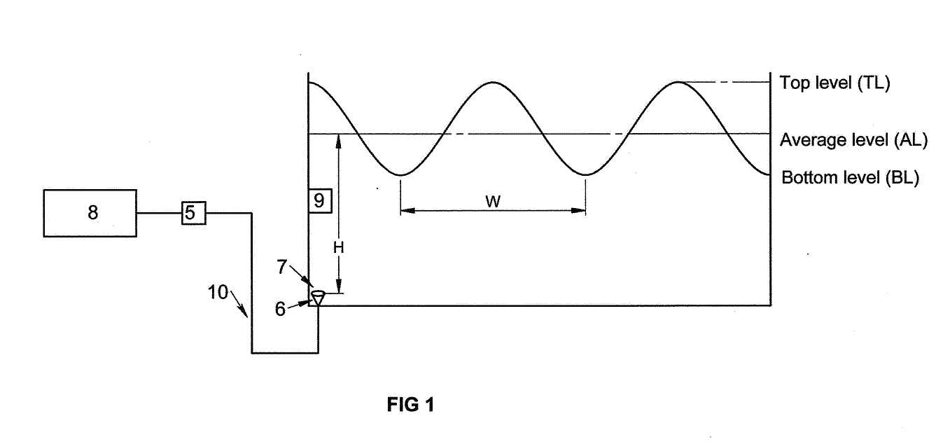

### DESCRIPTION OF PREFERRED EMBODIMENTS

In the preferred embodiments, the invention relates to the creation of a motion at the surface of a liquid, i.e. waves.

The pool 1, for example a substantially rectangular swimming pool, is provided with a system 2 for creating waves 3 at the surface 4 of a liquid contained in the pool presenting an average level (AL). Said waves 3 follow at least one substantially sinusoidal pattern having a wavelength, a frequency or a phase period corresponding to the inverse of the frequency, said wave having a height varying between a bottom level (BL) below the average level at specific moments and a top level (TL) above the average level at specific other moments. The system is placed at a corner of the pool.

The system 2 comprises:
a means 5 for introducing intermittently a gas into the liquid at a flow rate of less than 40 litres of gas per second. Said means 5 comprises at least one end piping assembly 6 having an end opening system 7 with a total open end cross section of about 10 cm², whereby said gas at the end opening system 7 is submitted to a pressure resulting in a gas flow, corresponding to the liquid height from the end opening system 7 up to the surface of the liquid, the end piping being for example fixed to the bottom of the pool,
a gas flow means 8 (such as an air blower with a buffer tank able to accumulate the gas) adapted for increasing the flow of the gas, said increase resulting in gas flow at the end opening 7 of the end piping assembly 6 up to a pressure greater than the pressure corresponding to the sum of the liquid height from the end opening of the end pipe to the surface of the liquid with an additional liquid height of at least 25 cm, but lower than a pressure corresponding to the sum of the liquid height from the end opening of the end pipe and an additional liquid height of 2 meters, and
a control means 9 for controlling the pressure at the end opening 7 at least in function of the height of the wave vertically above the end opening system 7, said control means being adapted for achieving said at least one pattern to permit the gas flow means to increase the pressure of the gas, said increase resulting in gas flow at the end opening of the piping assembly 6 at first moments for which the wave above the open end assembly 6 is in an phase corresponding to an advance of phase of about 5° to 90° with respect to moments of low level of the phase of the wave, up to a pressure greater than the pressure corresponding to the sum of the liquid height from the end opening of the end pipe to the surface of the liquid with an additional liquid height of about 50 cm and with an second additional pressure exerted on the liquid at its surface (said second additional pressure is substantially zero, when the surface of the pool is submitted to a void, while said second additional pressure is about 1 atmosphere when the surface of the pool is at atmospheric pressure or a higher pressure when the surface of the pool is under pressure), while said control means 9 is adapted for maintaining the pressure in the end receiving chamber below a pressure corresponding to the liquid height above the end piping assembly 6 for the wave phases above the end opening 7, except at the said first moments.

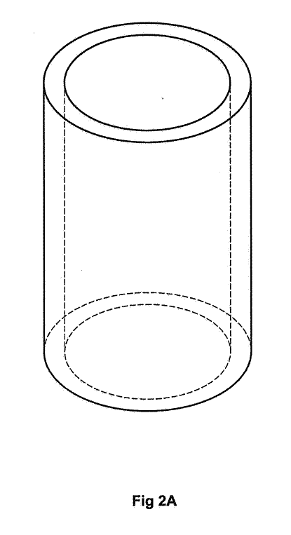

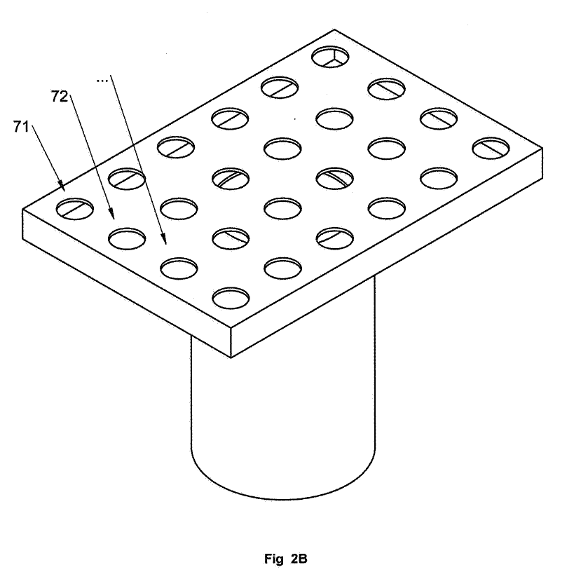

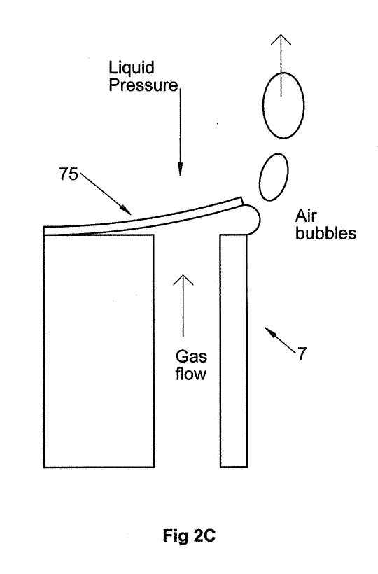

The end piping assembly 6 has a single opening 7 communicating with the pool (FIG. 2A). In another possible embodiment (see FIG. 2B), the open end system comprises several distinct openings 70,71,etc. communicating with the pool. When the average level of liquid is lower than 1.2 m, an end piping assembly with several end openings distributed on an area up to 1 m² has a better efficiency than an end piping assembly with a single end opening. According to an advantageous detail, the end piping assembly is provided with a non-return valve or membrane 75 so that the liquid can't penetrate into the end piping assembly (FIG. 2C). As soon as the gas pressure at the end opening 7 is higher than the pressure of the liquid (liquid height), the membrane is moved upwardly, so as to enable the passage of gas into the pool.

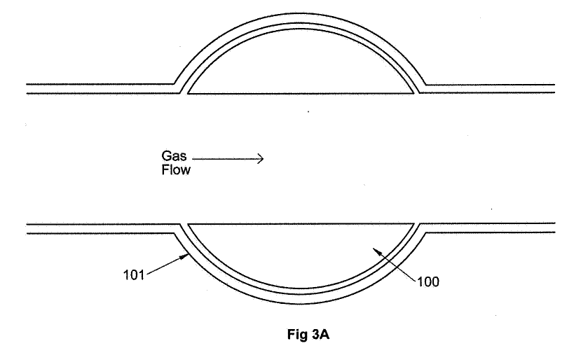

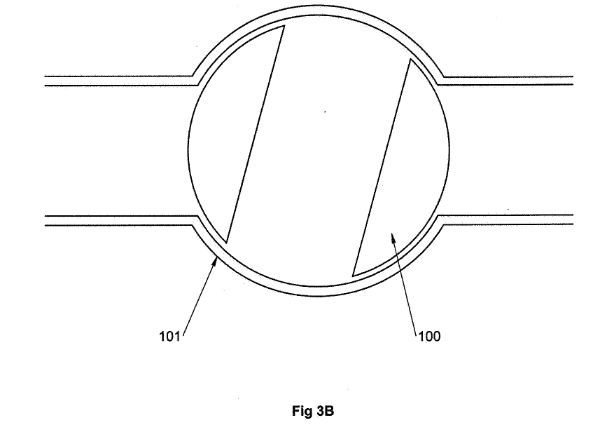

According to a further embodiment, the means for introducing intermittently the gas 5 is a system mobile (such a rotating valve 100 moving in a body 101 connected to the end piping assembly 6) between at least an open position and a closed position, such as shown in FIGS. 3A (open position enabling the passage of gas under pressure) and 3B (closed position).

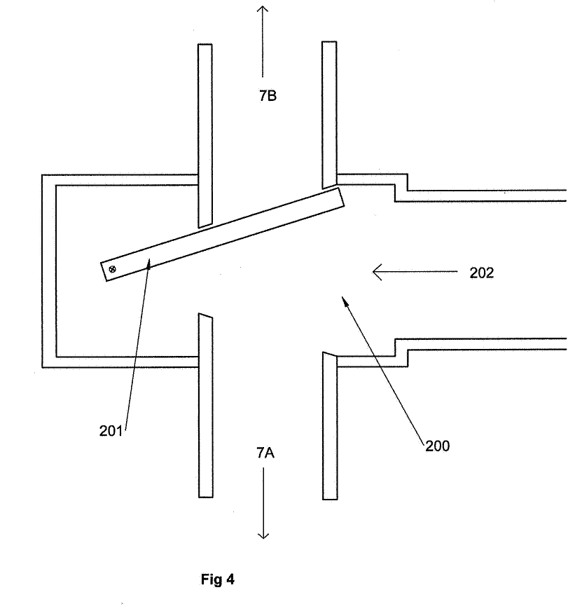

According to another embodiment, the means for introducing intermittently the gas 5 is especially dedicated for two end piping assemblies (FIG. 4). Said means comprises a chamber 200 provided with a moving valve 201, said chamber having one inlet opening 202 and two outlets connected to end openings 7A,7B. Said valve 201 moves between a first position enabling gas to flow through the end opening 7B, while preventing gas to flow through the end opening 7A, and a second position enabling gas to flow through the end opening 7A, while preventing gas to flow through the end opening 7B.

The open end system 7 is located about 100 cm to 200 cm (H) below the average level of liquid AL in the pool, for example on the bottom of the pool.

The control means 9 is adapted for controlling the escape of gas from each end piping assembly into the liquid during a time period corresponding to less than 0.8 times the time of the phase period of the wave W, preferably between 0.1 and 0.5 times the time or duration of the phase period of the wave.

The end piping assembly 6 is connected via a connecting pipe 10 to a source of gas flow under pressure 8.

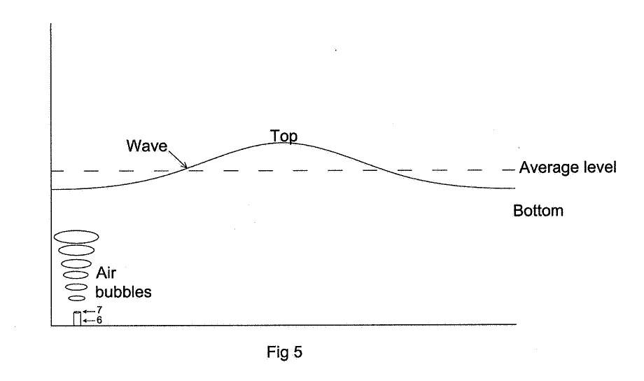

When the wave is in a position in advance to a hollow position of the wave (FIG. 5), the means 5 is in open position so as to enable air to flow through the pipe 10. The pressure at the end opening 7 increases to a pressure higher than the sum of atmospheric pressure with a pressure corresponding to the liquid height. When air is expelled from the end opening 7, said air forms gas bubbles flowing upwardly (arrow Y). Said air bubbles push and pull liquid upwardly and force the level of liquid to increase up to the top level (TL).

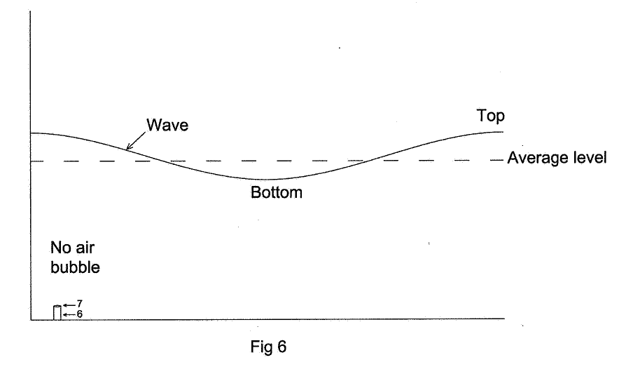

During a time corresponding to around a half period of the phase of the wave (around 180°), bubbles with a total volume of about 40 litres are escaping through the end opening 7, then the means 5 is placed in closed position as to stop the passage of air in the pool. No air (FIG. 6) is then injected in the pool up to the moment corresponding further to a hollow position of the wave. In case the wave pattern has to changed, the moment of introduction of air in the pool can be modified.

What I claim is:

1. A system for creating a motion selected from the group consisting of liquid motions in a liquid, liquid motions at the surface of a liquid ( in particular resulting in waves at the surface thereof) and combinations thereof, said liquid contained in a pool presenting an average level, said motion following at least one substantially sinusoidal pattern having a phase and with a height varying between a bottom level below the average level at specific moments and a top level above the average level at specific other moments, this system comprising:
a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly and an additional liquid height of 5 meters, and
a control means for controlling the flow of the gas at the end opening of the end piping assembly at least in function of the height of the motion vertically above the end opening, said control means being adapted for achieving, said at least one pattern, to permit the gas flow means to increase the pressure of the gas, said increase resulting in gas flow at the end opening of the end piping assembly at first moments for which the liquid above the open end assembly is in phase corresponding to an advance of phase comprised between 0° and 180° with respect to moments of low level of the phase of the motion, up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly to the surface of the liquid with an additional liquid height of 5 meters, while said control means is adapted for maintaining the pressure in the end piping assembly at or slightly below a pressure corresponding to the liquid height above the end piping assembly for the liquid motion phases except the said first moments.

2. The system of claim 1, in which said control means is adapted for achieving said at least one pattern to permit the gas flow means to increase the pressure of the gas, said increase resulting in gas flow at said end opening at first moments for which the wave above the end piping assembly is in an phase corresponding to an advance of phase comprised between 5° and 90° with respect to moments of low level of the phase of the motion, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 1 meter.

3. The system of claim 1, in which said control means is adapted for achieving said at least one pattern to permit the gas flow means to increase the pressure of the gas, said increase resulting in gas flow at said end opening at first moments for which the motion above the end piping assembly is in an phase corresponding to an advance of phase comprised between 10° and 45° with respect to moments of low level of the phase of the motion, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 5 meters.

4. The system of claim 1, in which said control means is adapted for achieving said at least one pattern to permit the gas flow means to increase the pressure of the gas, said increase resulting in gas flow at said end opening at first moments for which the motion above the end piping assembly is in an phase corresponding to an advance of phase comprised between 5° and 90° with respect to moments of low level of the phase of the motion, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

5. The system of claim 1, in which said control means is adapted for achieving said at least one pattern to permit the gas flow means to increase the pressure of the gas, said increase resulting in gas flow at said end opening at first moments for which the motion above the end piping assembly is in an phase corresponding to an advance of phase comprised between 10° and 45° with respect to moments of low level of the phase of the wave, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

6. The system of claim 1, in which the open end system has a total open end cross section of at least 10 cm² within a pattern with an area up to 1 m².

7. The system of claim 1, in which the open end system has a total open end cross section comprised between 10 cm² and 100 cm².

8. The system of claim 1, in which the open end system has a total open end cross section comprised between 10 cm² and 50 cm².

9. The system of claim 1, in which the open end system has a single opening communicating with the pool.

10. The system of claim 1, in which the open end system comprises several distinct openings communicating with pool.

11. The system of claim 1, in which the means for introducing intermittently a gas into the liquid is a system mobile between at least an open position and a closed position.

12. The system of claim 1, in which the open end system is located at least 50 cm below the average level of liquid in the pool.

13. The system of claim 1, in which the open end system is located between 100 cm and 300 cm below the average level of liquid in the pool.

14. The system of claim 1, in which the control means is adapted for controlling the escape of gas from each end piping assembly into the liquid during a time period corresponding to less than 0.8 times the phase period of the wave.

15. The system of claim 1, in which the control means is adapted for controlling the escape of gas from each end piping assembly into the liquid during a time period comprised between 0.1 and 0.5 times the phase period of the wave.

16. The system of claim 1, in which the control means is adapted for controlling the escape of gas from each end piping assembly into the liquid during a time period comprised between 0.01 and 0.5 times the phase period of the wave.

17. A system for creating a motion selected from the group consisting of liquid motions in a liquid, liquid motions at the surface of a liquid ( in particular resulting in waves at the surface thereof) and combinations thereof, said liquid contained in a pool presenting an average level, said motion following at least one substantially sinusoidal pattern having a phase and with a height varying between a bottom level below the average level at specific moments and a top level above the average level at specific other moments, this system comprising:
a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly and an additional liquid height of 5 meters, and
a control means for controlling the flow of the gas at the end opening of the end piping assembly at least in function of the height of the motion vertically above the end opening, said control means being adapted for achieving, said at least one pattern, to permit gas flow at the end opening of the end piping assembly at first moments for which the liquid above the open end assembly is in phase corresponding to an advance of phase comprised between 0° and 180° with respect to moments of low level of the phase of the motion, said gas flowing at a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly to the surface of the liquid with an additional liquid height of 5 meters, while said control means is adapted for stopping the liquid flow through the end opening for the motion phases except the said first moments.

18. The system of claim 17 in which the open end system has a total open end cross section of at least 10 cm² within a pattern with an area up to 1 m².

19. The system of claim 17, in which the open end system has a total open end cross section comprised between 10 cm² and 100 cm².

20. The system of claim 17, in which the open end system has a total open end cross section comprised between 10 cm² and 50 cm².

21. A pool adapted for containing a liquid with an average level, said pool being provided with a system for creating a motion selected from the group consisting of liquid motions in a liquid, liquid motions at the surface of a liquid ( in particular resulting in waves at the surface thereof) and combinations thereof, said waves following at least one substantially sinusoidal pattern having a phase and with a height varying between a bottom level below the average level at specific moments and a top level above the average level at specific other moments, whereby this system comprises
a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
a gas flow means adapted for increasing the pressure of the gas, said increase resulting in gas flow at the end opening of the end piping assembly up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly and an additional liquid height of 5 meters, and
a control means for controlling the flow of the gas at the end opening of the end piping assembly at least in function of the height of the liquid vertically above the end opening, said control means being adapted for achieving, said at least one pattern, to permit the gas flow means to increase the pressure of the gas, said increase resulting in gas flow in said end piping assembly at first moments for which the motion above the open end assembly is in phase corresponding to an advance of phase comprised between 0° and 180° with respect to moments of low level of the phase of the motion, up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly to the surface of the liquid with an additional liquid height of 5 meters, while said control means is adapted for maintaining the pressure in the end piping assembly at or slightly below a pressure corresponding to the liquid height above the end piping assembly for the motion phases except the said first moments.

22. The pool of claim 21, in which said control means of the system is adapted for achieving said at least one pattern to permit the gas flow means to increase the pressure of the gas , said increase resulting in gas flow at said end opening at first moments for which the wave above the open end assembly is in an phase corresponding to an advance of phase comprised between 5° and 90° with respect to moments of low level of the phase of the wave, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 5 meters.

23. The pool of claim 21, in which said control means of the system is adapted for achieving said at least one pattern to permit the gas flow means to increase the pressure of the gas, said increase resulting in gas flow at said end opening at first moments for which the liquid motion above the open end assembly is in an phase corresponding to an advance of phase comprised between 10° and 45° with respect to moments of low level of the phase of the wave, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 5 meters.

24. The pool of claim 21, in which said control means of the system is adapted for achieving said at least one pattern to permit the gas flow means to increase the pressure of the gas, said increase resulting in gas flow at said end opening at first moments for which the wave above the open end assembly is in an phase corresponding to an advance of phase comprised between 5° and 90° with respect to moments of low level of the phase of the motion, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

25. The pool of claim 21, in which said control means of the system is adapted for achieving said at least one pattern to permit the gas flow means to increase the pressure of the gas, said increase resulting in gas flow at said end opening at first moments for which the liquid motion above the open end assembly is in an phase corresponding to an advance of phase comprised between 10° and 45° with respect to moments of low level of the phase of the motion, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

26. The pool of claim 21, in which the end opening has a total open end cross section of at least 10 cm² within a pattern with an area up to 1 m².

27. The pool of claim 21, in which the end opening has a total open end cross section comprised between 10 cm² and 100 cm².

28. The pool of claim 21, in which the end opening has a total open end cross section comprised between 10 cm² and 50 cm².

29. The pool of claim 21, in which the end piping assembly has a single opening communicating with the pool.

30. The pool of claim 21, in which the end piping assembly comprises several distinct openings communicating with the pool.

31. The pool of claim 21, in which the means for introducing intermittently a gas into the liquid is a system mobile between at least an open position and a closed position.

32. The pool of claim 21, in which the open end system is located at least 50 cm below the average level of liquid in the pool.

33. The pool of claim 21, in which the open end system is located between 100 cm and 300 cm below the average level of liquid in the pool.

34. The pool of claim 21, in which the control means is adapted for controlling the escape of gas from each end piping assembly into the liquid during a time period corresponding to less than 0.8 times the phase period of the wave.

35. The pool of claim 21, in which the control means is adapted for controlling the escape of gas from each end piping assembly into the liquid during a time period comprised between 0.1 and 0.5 times the phase period of the wave.

36. The pool of claim 21, in which the control means is adapted for controlling the escape of gas from each end piping assembly into the liquid during a time period comprised between 0.01 and 0.5 times the phase period of the wave.

37. A pool adapted for containing a liquid with an average level, said pool being provided with a system for creating a motion selected from the group consisting of liquid motions in a liquid, liquid motions at the surface of a liquid ( in particular resulting in waves at the surface thereof) and combinations thereof, said waves following at least one substantially sinusoidal pattern having a phase and with a height varying between a bottom level below the average level at specific moments and a top level above the average level at specific other moments, whereby this system comprises:
a means for introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,

[symbol]

38. Th section

39. Th section

40. The system of claim 37, in which the open end system has a total open end cross section comprised between 10 cm² and 50 cm².

41. A method for creating a motion selected from the group consisting of liquid motions in a liquid, liquid motions at the surface of a liquid ( in particular resulting in waves at the surface thereof) and combinations thereof, said liquid contained in a pool presenting an average level, said liquid motion following at least one substantially sinusoidal pattern having a phase and with a height varying between a bottom level below the average level at specific moments and a top level above the average level at specific other moments, said method comprising the step of:
introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
increasing the pressure of the gas by a gas flow means, said increase resulting in a gas flow at the end opening of the end piping assembly up to a pressure greater than the pressure corresponding to the sum of the liquid height form the end opening of the end piping assembly to the surface of the liquid with an additional liquid height of at least 5 cm, but lower than a pressure corresponding to the sum of the liquid height from the end opening of the end piping assembly and an additional liquid height of 5 meters, and
controlling by a control means the flow of the gas at the end opening of the end piping assembly at least in function of the height of the liquid vertically above the end opening, said control means being adapted for achieving, said at least one pattern, to permit the gas flow means to increase the pressure of the gas, said increase resulting in gas flow in said end piping assembly at first moments for which the wave above the open end assembly is in phase corresponding to an advance of phase comprised between 0° and 180° with respect to moments of low level of the phase of the liquid motion, up to a pressure greater than the pressure corresponding to the sum of the liquid height from the end opening of the end piping assembly to the surface of the liquid with an additional liquid height of at least 5 cm, but lower than a pressure corresponding to the sum of the liquid height from the end opening of the end piping assembly to the surface of the liquid with an additional liquid height of 5 meters, while said control means is adapted for maintaining the pressure in the end piping assembly at or slightly below a pressure corresponding to the liquid height above the end piping assembly for the liquid motion phases except the said first moments.

42. The method of claim 41, in which for achieving said at least one liquid motion pattern, the controlling step is adapted to permit the gas flow means to increase the pressure of the gas, said increase resulting in gas flow in said end piping assembly at first moments for which the liquid motion above the open end assembly is in an phase corresponding to an advance of phase comprised between 5° and 90° with respect to moments of low level of the phase of the liquid motion, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 5 meters.

43. The method of claim 41, in which for achieving said at least one liquid motion pattern, the controlling step is adapted to permit the gas flow means to increase the pressure of the gas, said increase resulting in gas flow at the end opening of the end piping assembly at first moments for which the liquid motion above the open end assembly is in an phase corresponding to an advance of phase comprised between 10° and 45° with respect to moments of low level of the phase of the motion phases, up to a pressure greater than the pressure corresponding to the sum of the liquid height from the end opening of the end pipe to the surface of the liquid with an additional liquid height of at least 5 cm, but lower than a pressure corresponding to the sum of the liquid height from the end opening of the end pipe and an additional liquid height of 5 meters.

44. The method of claim 41, in which for achieving said at least one motion phases pattern, the controlling step is adapted to permit the gas flow means to increase the pressure of the gas, said increase resulting in gas flow at the end opening of the end piping assembly at first moments for which the liquid motion above the open end assembly is in an phase corresponding to an advance of phase comprised between 5° and 90° with respect to moments of low level of the phase of the liquid motion, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

45. The method of claim 41, in which for achieving said at least one liquid motion pattern, the controlling step is adapted to permit the gas flow means to increase the pressure of the gas, said increase resulting in gas flow at the end opening of the end piping assembly at first moments for which the liquid motion above the open end assembly is in an phase corresponding to an advance of phase comprised between 10° and 45° with respect to moments of low level of the phase of the liquid motion, up to a pressure greater than the pressure corresponding to the sum of the liquid height from the end opening of the end pipe to the surface of the liquid with an additional liquid height of at least 10 cm, but lower than a pressure corresponding to the sum of the liquid height from the end opening of the end pipe and an additional liquid height of 50 cm.

46. The method of claim 41, in which the open end system has a total open end cross section of at least 10 cm² within a pattern with an area up to 1 m².

47. The method of claim 41, in which the open end system has a total open end cross section comprised between 10 cm² and 100 cm².

48. The method of claim 41, in which the open end system has a total open end cross section comprised between 10 cm² and 50 cm².

49. The method of claim 41, in which the open end system has a single opening communicating with the pool.

50. The method of claim 41, in which the open end system comprises several distinct openings communicating with the pool.

51. The method of claim 41, in which the means for introducing intermittently a gas into the liquid is a system mobile between at least an open position and a closed position.

52. The method of claim 41, in which the open end system is located at least 50 cm below the average level of liquid in the pool.

53. The method of claim 41, in which the open end system is located between 100 cm and 300 cm below the average level of liquid in the pool.

54. The method of claim 41, in which the control means is adapted for controlling the escape of gas from each end piping assembly into the liquid during a time period corresponding to less than 0.8 times the phase period of the wave.

55. The method of claim 41, in which the control means is adapted for controlling the escape of gas from each end piping assembly into the liquid during a time period comprised between 0.1 and 0.5 times the phase period of the wave.

56. The method of claim 41, in which the control means is adapted for controlling the escape of gas from each end piping assembly into the liquid during a time period comprised between 0.01 and 0.5 times the phase period of the wave.

57. A method for creating a motion selected from the group consisting of liquid motions in a liquid, liquid motions at the surface of a liquid ( in particular resulting in waves at the surface thereof) and combinations thereof, said liquid contained in a pool presenting an average level, said liquid motion following at least one substantially sinusoidal pattern having a phase and with a height varying between a bottom level below the average level at specific moments and a top level above the average level at specific other moments, said method comprising the step of:
introducing intermittently a gas into the liquid, said means comprises at least one end piping assembly with a total open end cross section of at least 2 cm², each end piping assembly having a gas flow rate of less than 200 litres per second, whereby the gas is submitted to a pressure corresponding to the liquid height from the end opening up to the surface of the liquid,
controlling the gas flow flowing through the end opening of the open end piping assembly, said gas flowing at a pressure greater than the pressure corresponding to the sum of the liquid height form the end opening of the end piping assembly to the surface of the liquid with an additional liquid height of at least 5 cm, but lower than a pressure corresponding to the sum of the liquid height from the end opening of the end piping assembly and an additional liquid height of 5 meters,
whereby said gas flow control is operated by a control means at least in function of the height of the liquid vertically above the end opening, said control means being adapted for achieving a gas flow at said end piping assembly at first moments for which the liquid motion above the open end assembly is in a phase corresponding to an advance of phase comprised between 0° and 180° with respect to moments of low level of the phase of the liquid motion, while said control means is adapted for preventing the gas flow in said liquid through said end piping assembly for the liquid motion phases except the said first moments.
